(19) United States
(12) Patent Application Publication
(10) Pub. No.: US 2017/0130042 A1
(43) Pub. Date: May 11, 2017

(54) Rubber Composition for Outside Hood and Outside Hood for Railway Vehicle

(71) Applicant: The Yokohama Rubber Co., LTD., Tokyo (JP)

(72) Inventor: Tomohiro MORITA, Hiratsuka-shi, Kanagawa (JP)

(21) Appl. No.: 15/316,821

(22) PCT Filed: May 29, 2015
(86) PCT No.: PCT/JP2015/065629

§ 371 Date: Dec. 6, 2016

(30) Foreign Application Priority Data
Jun. 6, 2014 (JP) 2014-117721

(51) Int. Cl. C08L 23/16; C08K 13/02; B61D 17/20

(52) U.S. Cl. CPC C08L 23/16; B61D 17/20; C08K 13/02; B61D 1/00

(57) ABSTRACT

The present technology is: a rubber composition for an outside hood, the rubber composition containing, per 100 parts by mass of one type or two or more types of ethylene-propylene-diene terpolymers, at least 5 parts by mass of silica, and sulfur and/or a peroxide compound, a Mooney viscosity of the one type of ethylene-propylene-diene terpolymer being 50 or greater, a diene amount in the one type of ethylene-propylene-diene terpolymer being at least 8 mass % of the one type of ethylene-propylene-diene terpolymer, an average Mooney viscosity of the two or more types of ethylene-propylene-diene terpolymers being 50 or greater, and an average diene amount in the two or more types of ethylene-propylene-diene terpolymers being at least 8 mass % of the two or more types of ethylene-propylene-diene terpolymers; and an outside hood for a railway vehicle produced using the same.

### TECHNICAL FIELD

The present technology relates to a rubber composition for an outside hood and an outside hood for a railway vehicle.

### BACKGROUND ART

In between vehicles of railway vehicles (connecting unit of vehicles), outside hoods are provided mainly to avoid people from falling into a space formed between vehicles of a train from a railway platform, to reduce air resistance applied to the connecting unit of the vehicles, and the like.

The characteristics required for raw materials of the outside hood for a railway vehicle include, for example, excellent weatherability, excellent wear resistance, and the like.

An ethylene-propylene-diene terpolymer (EPDM) is a rubber having excellent weatherability, and the applicant of the present technology has previously proposed a rubber composition for an outside hood containing EPDM, silica, and the like (e.g. Japanese Unexamined Patent Application Publication No. 2008-274252A).

Although the rubber composition for an outside hood has excellent wear resistance, the inventor of the present technology has thought that the wear resistance of the composition containing EPDM, silica, and the like may be made even better.

### SUMMARY

The present technology provides a rubber composition for an outside hood with excellent wear resistance and an outside hood using such a composition.

As a result of diligent research, the inventor of the present technology has found that

a composition containing, per 100 parts by mass of one type or two or more types of ethylene-propylene-diene terpolymers,

at least 5 parts by mass of silica, and

at least one selected from the group consisting of sulfur and a peroxide compound,

a Mooney viscosity of the one type of ethylene-propylene-diene terpolymer being 50 or greater, a diene amount in the one type of ethylene-propylene-diene terpolymer being at least 8 mass % of the one type of ethylene-propylene-diene terpolymer,

an average Mooney viscosity of the two or more types of ethylene-propylene-diene terpolymers being 50 or greater, and an average diene amount in the two or more types of ethylene-propylene-diene terpolymers being at least 8 mass % of the two or more types of ethylene-propylene-diene terpolymers,

can be a rubber composition for an outside hood having excellent wear resistance, and thus completed the present technology.

Specifically, the inventor discovered that the problem described above can be solved by the following features.

[1] A rubber composition for an outside hood, the rubber composition comprising, per 100 parts by mass of one type or two or more types of ethylene-propylene-diene terpolymers,

5 parts by mass or greater of silica, and

at least one selected from the group consisting of sulfur and a peroxide compound,

a Mooney viscosity of the one type of ethylene-propylene-diene terpolymer being 50 or greater, a diene amount in the one type of ethylene-propylene-diene terpolymer being 8 mass % or greater of the one type of ethylene-propylene-diene terpolymer,

an average Mooney viscosity of the two or more types of ethylene-propylene-diene terpolymers being 50 or greater, and an average diene amount in the two or more types of ethylene-propylene-diene terpolymers being 8 mass % or greater of the two or more types of ethylene-propylene-diene terpolymers.

[2] The rubber composition for an outside hood according to [1] described above, where the amount of the silica is from 10 to 30 parts by mass per 100 parts by mass of the one type or two or more types of ethylene-propylene-diene terpolymers.

[3] The rubber composition for an outside hood according to [1] or [2] described above, where an amount of the sulfur is from 0.2 to 4 parts by mass per 100 parts by mass of the one type or two or more types of ethylene-propylene-diene terpolymers.

[4] The rubber composition for an outside hood according to any one of [1] to [3] described above, where an amount of the peroxide compound is from 1 to 10 parts by mass per 100 parts by mass of the one type or two or more types of ethylene-propylene-diene terpolymers.

[5] The rubber composition for an outside hood according to any one of [1] to [4] described above, further comprising diethylene glycol, where

an amount of the diethylene glycol is from 0.1 to 3 parts by mass per 100 parts by mass of the one type or two or more types of ethylene-propylene-diene terpolymers.

[6] The rubber composition for an outside hood according to any one of [1] to [5] described above, further comprising carbon black, where

an amount of the carbon black is 10 parts by mass or less per 100 parts by mass of the one type or two or more types of ethylene-propylene-diene terpolymers.

[7] The rubber composition for an outside hood according to any one of [1] to [6] described above, comprising the two or more types of ethylene-propylene-diene terpolymers, where

at least one type of the two or more types of ethylene-propylene-diene terpolymers is an ethylene-propylene-diene terpolymer having a Mooney viscosity of 50 or greater, and

at least another one type of the two or more types of ethylene-propylene-diene terpolymers is an ethylene-propylene-diene terpolymer having a Mooney viscosity of less than 50.

[8] The rubber composition for an outside hood according to any one of [1] to [7] described above, comprising the two or more types of ethylene-propylene-diene terpolymers, where among the two or more types of ethylene-propylene-diene terpolymers, each of diene amounts of at least two types of ethylene-propylene-diene terpolymers is 8 mass % or greater of each of the ethylene-propylene-diene terpolymers.

[9] The rubber composition for an outside hood according to any one of [1] to [8] described above, further comprising a flame retardant.

[10] The rubber composition for an outside hood according to any one of [1] to [9] described above, where the amount of the sulfur is from 0.1 to 4 parts by mass per 100 parts by mass of the one type or two or more types of ethylene-propylene-diene terpolymers.

[11] The rubber composition for an outside hood according to any one of [1] to [10] described above, comprising the two or more types of ethylene-propylene-diene terpolymers, where

among the two or more types of ethylene-propylene-diene terpolymers, a diene amount of at least one type of ethylene-propylene-diene terpolymer is 5 mass % or less of the at least one type of ethylene-propylene-diene terpolymer.

[12] The rubber composition for an outside hood according to any one of [1] to [11] described above, comprising three types of the ethylene-propylene-diene terpolymers, where

among the three types of ethylene-propylene-diene terpolymers, a diene amount of one type of ethylene-propylene-diene terpolymer X is 5 mass % or less of the one type of ethylene-propylene-diene terpolymer X.

[13] The rubber composition for an outside hood according to any one of [1] to [12] described above, further comprising a silane coupling agent, where

a content of the silane coupling agent is from 0.1 to 10 parts by mass per 100 parts by mass of the one type or two or more types of ethylene-propylene-diene terpolymers.

[14] The rubber composition for an outside hood according to [13] described above, where the silane coupling agent is a sulfur-based silane coupling agent having a sulfur atom.

[15] An outside hood for a railway vehicle produced by using the rubber composition for an outside hood described in any one of [1] to [14] described above.

The rubber composition for an outside hood of the present technology and the outside hood of the present technology have excellent wear resistance.

### BRIEF DESCRIPTION OF DRAWINGS

FIG. 1 is a schematic partial perspective view for explaining an embodiment in a state where the outside hood of the present technology is installed on a vehicle.

FIG. 2 is a cross-sectional view along line A-A in FIG. 1.

FIG. 3 is a partial perspective view schematically illustrating an example of a sheet body.

FIG. 4 is an explanatory view illustrating an example of a method of installing the sheet body.

FIG. 5 is an explanatory view illustrating an example of connection between a linear member 3 and a shoulder member 4.

### DETAILED DESCRIPTION

The present technology is described in detail below.

### Rubber Composition for Outside Hood

The rubber composition for an outside hood of the present technology (rubber composition of the present technology) is a rubber composition for an outside hood,

the rubber composition comprising, per 100 parts by mass of one type or two or more types of ethylene-propylene-diene terpolymers,

5 parts by mass or greater of silica, and

sulfur and/or a peroxide compound,

a Mooney viscosity of the one type of ethylene-propylene-diene terpolymer being 50 or greater, a diene amount in the one type of ethylene-propylene-diene terpolymer being 8 mass % or greater of the one type of ethylene-propylene-diene terpolymer,

an average Mooney viscosity of the two or more types of ethylene-propylene-diene terpolymers being 50 or greater, and an average diene amount in the two or more types of ethylene-propylene-diene terpolymers being 8 mass % or greater of the two or more types of ethylene-propylene-diene terpolymers.

In the present technology, it is conceived that, by setting the diene amount or average diene amount of the ethylene-propylene-diene terpolymer (EPDM) to be 8 mass % or greater, high crosslinking density of the EPDM is achieved, thereby exhibiting excellent wear resistance. Furthermore, it is also conceived that excellent tensile properties are achieved.

Furthermore, it is conceived that, by setting the Mooney viscosity or average Mooney viscosity of the EPDM to be 50 or greater, excellent wear resistance and tensile properties are achieved.

Note that the mechanism described above is a deduction of the present inventor, and, even in cases involving different mechanisms, such mechanisms are within the scope of the present technology.

In the present technology, the Mooney viscosity (ML₁₊₄) of the EPDM was measured using a Mooney viscometer with an L type rotor in accordance with JIS (Japanese Industrial Standard) K6300-1:2013 in the following conditions: preheating time of 1 minute, duration of rotation of rotor of 4 minutes, temperature of 100° C., at 2 rpm.

Furthermore, in the present technology, the diene amount of the EPDM was evaluated in accordance with ASTM D 6047.

In the specification of the present technology, when the amount of each component is described, the amount is sometimes described based on “per 100 parts by mass of the one type or two or more types of ethylene-propylene-diene terpolymers”. “Per 100 parts by mass of the one type or two or more types of ethylene-propylene-diene terpolymers” means “per 100 parts by mass of the one type of EPDM” or “per 100 parts by mass total of the two or more types of EPDMs”. Ethylene-propylene-diene terpolymer

The rubber composition of the present technology contains one type or two or more types of ethylene-propylene-diene terpolymers (EPDMs).

The EPDM contained in the rubber composition of the present technology is a copolymer in which ethylene, propylene, and diene-based monomers are used as monomers.

The ethylene, propylene, and diene-based monomers used as the monomers are not particularly limited. Examples of the diene-based monomer include dicyclopentadiene, methylene norbornene, ethylidene norbornene, 1,4-hexadiene, and cyclooctadiene. Among these, from the perspective of excellent processability, dicyclopentadiene is preferable.

### One Type of Ethylene-Propylene-Diene Terpolymer

When one type of EPDM is contained in the rubber composition of the present technology, the Mooney viscosity of the one type of ethylene-propylene-diene terpolymer is 50 or greater and the diene amount of the one type of ethylene-propylene-diene terpolymer is 8 mass % or greater of the one type of ethylene-propylene-diene terpolymer.

The Mooney viscosity of the one type of ethylene-propylene-diene terpolymer is preferably from 50 to 90, more preferably from 50 to 80, and even more preferably 55 to 70, from the perspective of achieving even better wear resistance and excellent tensile properties.

The diene amount of the one type of ethylene-propylene-diene terpolymer is preferably from 8 to 20 mass %, and more preferably from 9 to 15 mass %, of the one type of ethylene-propylene-diene terpolymer from the perspective of achieving even better wear resistance and excellent tensile strength at break. Two or more types of ethylene-propylene-diene terpolymer

When two or more types of EPDMs are contained in the rubber composition of the present technology, the average Mooney viscosity of the two or more types of ethylene-propylene-diene terpolymers is 50 or greater and the average diene amount of the two or more types of ethylene-propylene-diene terpolymers is 8 mass % or greater of the two or more types of ethylene-propylene-diene terpolymer.

The average Mooney viscosity of the two or more types of ethylene-propylene-diene terpolymers is preferably from 50 to 90, and more preferably from 55 to 70, from the perspective of achieving even better wear resistance and excellent tensile strength at break.

The average diene amount of the two or more types of ethylene-propylene-diene terpolymers is preferably from 8 to 20 mass %, and more preferably from 9 to 15 mass %, of the two or more types of ethylene-propylene-diene terpolymers from the perspective of achieving even better wear resistance and excellent tensile strength at break.

When the rubber composition of the present technology contains the two or more types of ethylene-propylene-diene terpolymers, an example of a preferable aspect is one in which, among the two or more types of ethylene-propylene-diene terpolymers, at least one type is an ethylene-propylene-diene terpolymer having the Mooney viscosity of 50 or greater, and at least another one type is an ethylene-propylene-diene terpolymer having the Mooney viscosity of less than 50.

The content of the ethylene-propylene-diene terpolymer having the Mooney viscosity of less than 50 is preferably from 40 to 70 mass %, and more preferably from 40 to 55 mass %, relative to the total content of the two or more types of ethylene-propylene-diene terpolymers from the perspective of achieving even better wear resistance.

Furthermore, when the rubber composition of the present technology contains the two or more types of ethylene-propylene-diene terpolymers, an example of a preferable aspect is one in which, among the two or more types of ethylene-propylene-diene terpolymers, each of the diene amounts of at least two types of ethylene-propylene-diene terpolymers is 8 mass % or greater of each of the ethylene-propylene-diene terpolymers.

Furthermore, when the rubber composition of the present technology contains the two or more types of ethylene-propylene-diene terpolymers, an example of a preferable aspect is one in which, among the two or more types of ethylene-propylene-diene terpolymers, the diene amount of at least one type of ethylene-propylene-diene terpolymer is 5 mass % or less of the at least one type of ethylene-propylene-diene terpolymer.

The content of the at least one type of ethylene-propylene-diene terpolymer having the diene amount of 5 mass % or less is preferably from 1 to 50 mass %, and more preferably from 1 to 30 mass %, relative to the total content of the two or more types of ethylene-propylene-diene terpolymers from the perspective of achieving excellent tensile strength at break and/or elongation at break while excellent wear resistance is maintained.

The Mooney viscosity of the ethylene-propylene-diene terpolymer having the diene amount of 5 mass % or less is not particularly limited. For example, the Mooney viscosity can be set to 50 or greater and/or less than 50. An example of a preferable aspect is one in which the viscosity is 50 or greater.

The Mooney viscosity of the ethylene-propylene-diene terpolymer except the ethylene-propylene-diene terpolymer having the diene amount of 5 mass % or less (in this case, the diene amount of each of the EPDM is preferably greater than 8 mass %) is not particularly limited. For example, the Mooney viscosity can be set to 50 or greater and/or less than 50.

Furthermore, when the rubber composition of the present technology contains three types of ethylene-propylene-diene terpolymers, an example of a preferable aspect is one in which, among the three types of ethylene-propylene-diene terpolymers, the diene amount of one type of ethylene-propylene-diene terpolymer X is 5 mass % or less of the one type of ethylene-propylene-diene terpolymer X from the perspective of achieving excellent tensile strength at break and/or elongation at break.

The weight average molecular weight of EPDM is preferably from 1.0×10⁵ to 2.0×10⁶, and more preferably from 1.5×10⁵ to 10.0×10⁵, from the perspective of achieving excellent wear resistance and excellent tensile properties. In the present technology, the weight average molecular weight of the EPDM is determined by gel permeation chromatography (GPC) using orthodichlorobenzene as a solvent, measured based on calibration with polystyrene standard.

The method of producing EPDM is not particularly limited. Examples thereof include conventionally known methods.

### Silica

The silica will be described below.

The silica contained in the rubber composition of the present technology is not particularly limited. Examples thereof include hydrated silica, anhydrous silica, precipitated silica, and fumed silica. The silica may be, for example, silica which has undergone surface treatment by a surface treating agent, such as fatty acids and fatty acid esters.

A single silica can be used alone, or a combination of two or more types can be used.

In the present technology, the amount of the silica is 5 parts by mass or greater per 100 parts by mass of the one type or two or more types of EPDMs. The amount of the silica is preferably from 10 to 50 parts by mass, more preferably from 15 to 40 parts by mass, and even more preferably from 15 to 30 parts by mass, per 100 parts by mass of the one type or two or more types of EPDMs from the perspective of achieving even better wear resistance, excellent tensile properties, and excellent processability.

### Sulfur

The sulfur will be described below.

The sulfur that can be contained in the rubber composition of the present technology is not particularly limited as long as it is sulfur used in vulcanization of rubbers. Examples thereof include conventionally known sulfur. A single sulfur can be used alone, or a combination of two or more types can be used.

The amount of the sulfur is preferably from 0.1 to 4 parts by mass, more preferably from 0.2 to 4 parts by mass, and even more preferably from 0.5 to 3.0 parts by mass, per 100 parts by mass of the one type or two or more types of EPDMs from the perspective of achieving even better wear resistance and excellent tensile properties.

### Peroxide Compound

The peroxide compound will be described below.

The peroxide compound that can be contained in the rubber composition of the present technology is not particularly limited as long as it is a peroxide compound used in crosslinking of rubbers.

Examples thereof include dicumyl peroxide, di-t-butyl peroxide, t-butylcumyl peroxide, benzoyl peroxide, and 1,3-bis(t-butylperoxyisopropyl)benzene.

Among these, from the perspective of achieving excellent crosslinking effect, dicumyl peroxide is preferable.

A single peroxide compound can be used alone, or a combination of two or more types can be used.

The amount of the peroxide compound is preferably from 1 to 15 parts by mass, and more preferably from 3 to 10 parts by mass, per 100 parts by mass of the one type or two or more types of EPDMs from the perspective of achieving even better wear resistance.

### Other Components

### Diethylene Glycol

The rubber composition of the present technology may further contain diethylene glycol.

The diethylene glycol can stabilize dispersion of the silica.

When the rubber composition of the present technology further contains diethylene glycol, even better wear resistance and excellent tensile properties are achieved.

The amount of diethylene glycol is preferably from 0.1 to 3 parts by mass, and more preferably from 0.5 to 2.0 parts by mass, per 100 parts by mass of the one type or two or more types of EPDMs from the perspective of achieving even better wear resistance and excellent tensile properties.

### Flame Retardant

The rubber composition of the present technology may further contain a flame retardant.

The flame retardant that may be further contained in the rubber composition of the present technology is not particularly limited. Examples thereof include phosphorus-based flame retardants, halogen-based flame retardants such as ethylenebis(pentabromophenyl), and inorganic compound-based flame retardants. Furthermore, for example, the following (1) or (2) can be used as the flame retardant.

(1) At least one type or all selected from the group consisting of aluminum hydroxide, alkylenebis(halogenated phenyl), decabromodiphenyl ether, and ammonium polyphosphate.

Note that examples of the alkylenebis(halogenated phenyl) include ethylenebis(pentabromophenyl).

(2) At least one type or all selected from the group consisting of aluminum hydroxide, chlorinated paraffin, and antimony trioxide.

The amount of the flame retardant is preferably from 5 to 100 parts by mass, more preferably from 5 to 90 parts by mass, and even more preferably from 10 to 50 parts by mass, per 100 parts by mass of the one type or two or more types of EPDMs from the perspectives of maintaining excellent wear resistance, achieving excellent tensile properties and flame retardancy as well as excellent balance of wear resistance and/or tensile properties and flame retardancy.

### Carbon Black

The rubber composition of the present technology may further contain carbon black.

When the rubber composition of the present technology further contains carbon black, even better wear resistance and excellent tensile properties are achieved.

The carbon black that may be further contained in the rubber composition of the present technology is not particularly limited. Examples thereof include conventionally known carbon black.

The amount of the carbon black is preferably from 30 parts by mass or less, and more preferably from 5 to 10 parts by mass, per 100 parts by mass of the one type or two or more types of EPDMs from the perspective of achieving even better wear resistance.

### Silane Coupling Agent

The rubber composition of the present technology preferably further contains a silane coupling agent from the perspective of achieving even better wear resistance, excellent dispersibility of the silica, and excellent elongation at break.

Examples of the silane coupling agent include amino silane coupling agents, epoxy silane coupling agents, hydroxy silane coupling agents, and sulfur-based silane coupling agents (silane coupling agents containing a sulfur atom).

Among these, from the perspective of accelerating vulcanization of the ethylene-propylene-diene terpolymer, a sulfur-based silane coupling agent is preferable.

Examples of the sulfur-based silane coupling agent include polysulfide-based silane coupling agents, such as bis(3-triethoxysilylpropyl) tetrasulfide, 3-trimethoxysilylpropyl benzothiazole tetrasulfide, and bis(3-triethoxysilylpropyl) disulfide; mercapto-based silane coupling agents, such as γ-mercaptopropylmethyldimethoxysilane, γ-mercaptopropyltrimethoxysilane, and 3-[ethoxybis(3,6,9,12,15-pentaoxaoctacosan-1-yloxy)silyl]-1-propanethiol (Si 363, manufactured by Evonik Degussa); thiocarboxylate-based silane coupling agents, such as 3-octanoylthiopropyltriethoxysilane; and thiocyanate-based silane coupling agents, such as 3-thiocyanatepropyltriethoxysilane.

Among these, from the perspectives of achieving even better wear resistance and excellent dispersibility of the silica and being capable of accelerating vulcanization of the ethylene-propylene-diene terpolymer, a polysulfide-based silane coupling agent is preferable, and bis(3-triethoxysilylpropyl) tetrasulfide and bis(3-triethoxysilylpropyl) disulfide are more preferable.

The content of the silane coupling agent is preferably from 0.1 to 10 parts by mass, and more preferably from 0.1 to 3 parts by mass, per 100 parts by mass of the one type or two or more types of EPDMs from the perspective of achieving excellent elongation at break.

### Additives

In the rubber composition of the present technology, additives may be further contained as necessary in addition to the components described above in the range that does not impair the purpose of the present technology. The amount of the additives may be selected as desired.

Examples of the additives include zinc oxide; stearic acid; fillers except silica and carbon black (e.g. titanium oxide, clay, and talc), anti-aging agents, antioxidants, pigments (e.g. a black master batch containing a pigment can be used), dyes, softening agents such as paraffin oils, plasticizers, UV absorbents, solvents, surfactants (including leveling agents), dispersing agents, dehydrating agents, anticorrosives, adhesion-imparting agents, antistatic agents, thixotropy-imparting agents, vulcanization accelerators, and vulcanization accelerator aids.

### Production Method

The method of producing the rubber composition of the present technology is not particularly limited. For example, the production can be performed by uniformly mixing the EPDM, silica, sulfur and/or peroxide compound, and the like using a roll, kneader, extruder, universal mixer, or the like.

Conditions for vulcanization and/or crosslinking of the rubber composition of the present technology are not particularly limited. For example, the vulcanization and/or crosslinking can be performed by applying pressure in a condition at 140 to 180° C.

The rubber composition of the present technology can be used as the rubber composition for an outside hood.

### Outside Hood

Next, the outside hood of the present technology will be described below.

The outside hood of the present technology is an outside hood for a railway vehicle and the outside hood is produced by using the rubber composition for an outside hood of the present technology.

The outside hood of the present technology exhibits excellent wear resistance by being produced by using the rubber composition for an outside hood of the present technology. The rubber composition used in the outside hood of the present technology is not particularly limited as long as it is the rubber composition of the present technology.

The configuration of the outside hood of the present technology is not particularly limited. For example, the outside hood may have a shape by which at least a part or the entire periphery of a space between a vehicle and another vehicle that follows the vehicle is covered at connecting unit of the vehicles.

Furthermore, the shape of the outside hood may be an annular shape or plate shape.

When the shape of the outside hood of the present technology is annular, the cross section of the annular structure may be, for example, a substantially U-shape (including the cross section having a substantially V-shape, or the like; hereinafter the same). Of these, the cross section is preferably a substantially U-shape. The substantially U-shape include shapes such as a substantially V-shape and substantially semicircle.

The shape of the outside hood can be changed depending on the shape of the vehicles to be used. For example, the two sides that form the substantially V-shape may be equal sides or unequal sides.

Furthermore, the outside hoods of the present technology may be installed on the rear edge of the front vehicle and the front edge of the rear vehicle in a manner that the outside hoods face each other. The outside hood installed on the rear edge of the front vehicle and the outside hood installed on the front edge of the rear vehicle may be in contact or may be separated.

When the outside hoods facing each other are in contact, it is possible to reduce air resistance and reduce noise.

When the outside hoods facing each other are separated, it is possible to elongate the life of the outside hoods since friction between the outside hoods is reduced.

An example of a preferable aspect is one in which the outside hood have linear members located at the top, bottom, left, and right of the space between the vehicles (left and right side portions, ceiling portion, and floor portion) in a manner that the entire periphery thereof is covered, and shoulder members arranged at the four corners to connect the linear members.

An example of a preferable aspect is one in which the rubber composition of the present technology is used in the linear members and/or the shoulder members.

The outside hood of the present technology will be described below while referring to the attached drawings. However, the present technology is not limited to the attached drawings. Furthermore, in each drawing, the same components are given the same reference numerals, and descriptions thereof are omitted and not repeated.

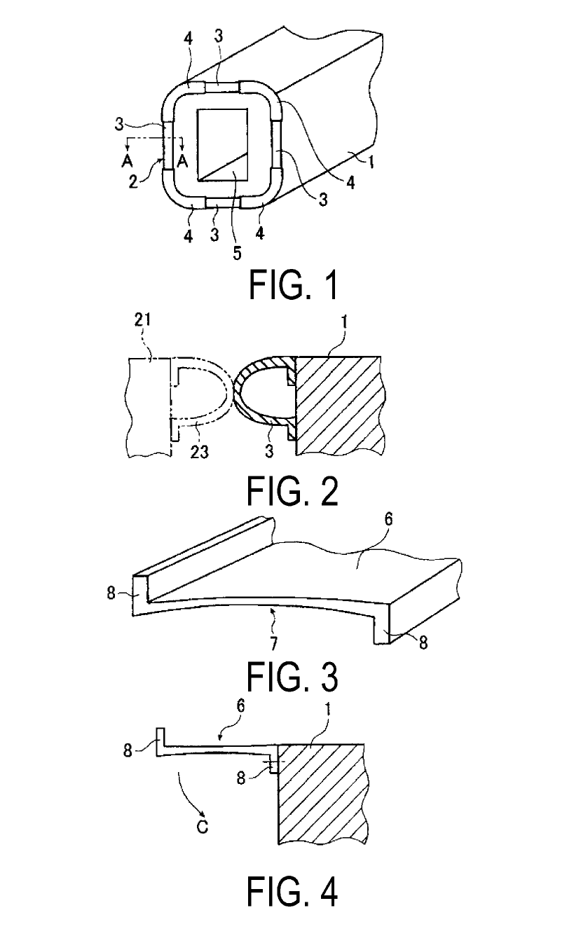

FIG. 1 is a schematic partial perspective view for describing an embodiment in a state where the outside hood of the present technology is installed on a vehicle.

As illustrated in FIG. 1, an outside hood 2 covers the entire periphery of a space between vehicles at a connecting unit of a vehicle 1. Furthermore, the outside hood 2 has four linear members 3 having an annular shape and being arranged at the top, bottom, left, and right (left and right side portions, ceiling portion, and floor portion), and four shoulder members 4. Note that, in the figure, 5 indicates an aisle in the vehicle 1.

FIG. 2 is a cross-sectional view along line A-A in FIG. 1.

As shown by solid line portions in FIG. 2, the linear member 3 has an annular structure portion (not indicated in the figure) and flange portions (not indicated in the figure). The linear member 3 is fixed on the vehicle 1 at the flange portions (not indicated in the figure). The cross section of the annular structure portion of the linear member 3 is a substantially U-shape.

Furthermore, in FIG. 2, a cross section of another vehicle 21 that is connected to the vehicle 1 and a cross section of a linear member 23 of an outside hood installed on the vehicle 21 are shown by dotted lines. The position of the cross section of the vehicle 21 and the linear member 23 corresponds to the position of the A-A cross section of the linear member 3.

The linear member 23 has an annular structure portion (not indicated in the figure) and flange portions (not indicated in the figure). The linear member 23 is fixed on the vehicle 21 at the flange portions (not indicated in the figure). The cross section of the annular structure portion of the linear member 23 is a substantially U-shape.

In FIG. 2, the linear member 23 and the linear member 3 are in contact and facing each other. The linear member 23 and the linear member 3 may be separated.

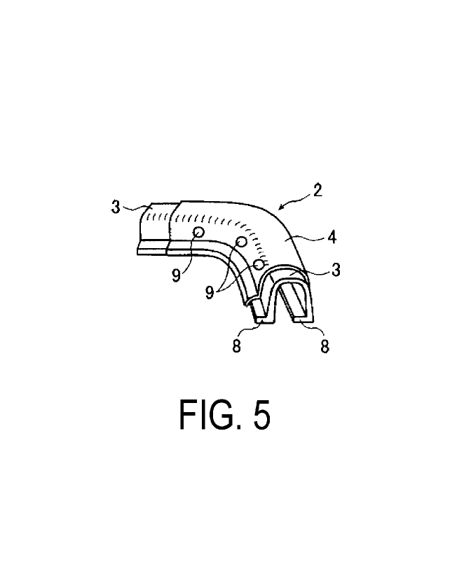

FIG. 5 is an explanatory view illustrating an example of connection between a linear member 3 and a shoulder member 4.

In FIG. 5, the linear member 3 and the shoulder member 4 can be connected by overlapping the edge portion in the longitudinal direction of the shoulder member 4 having a cross section in a substantially U-shape with the edge portion of the linear member 3 having a cross section in a substantially U-shape.

An example of a preferable aspect is one in which the outside hood of the present technology is formed from a sheet body having flexibility. The sheet body can be formed by using the rubber composition of the present technology.

Examples of the sheet body include a sheet body at least having a rubber layer formed by using the rubber composition of the present technology.

The sheet body may further have a reinforcing layer to enhance stiffness and restoration properties. Examples of the reinforcing layer include woven fabric formed from fibers of nylon, aramid, polyethylene terephthalate (PET), or the like.

An example of a preferable aspect is one in which the sheet body is a laminate body in which a rubber layer and a reinforcing layer are laminated.

When the sheet body has a reinforcing layer, for example, the reinforcing layer may be arranged in between two layers of rubber layers.

An example of a preferable aspect is one in which the sheet body has a flange portion, serving as a portion to be installed on a vehicle, and a main body part having a square shape. The flange portion can be provided on the edge portion of the main body part.

One sheet body can have one or two flange portions.

When the one sheet body has one flange portion, for example, a plate-like outside hood can be formed using the sheet body.

When the one sheet body has two flange portions on the both edge portions of the main body part in a manner that the both edge portions face each other, for example, an annular outside hood can be formed using the sheet body.

FIG. 3 is a partial perspective view schematically illustrating an example of a sheet body.

As illustrated in FIG. 3, the sheet body 6 has a main body part 7 and flange portions 8. The main body part 7 has a shape in which the central part thereof in the width direction is thin and the thickness thereof is increased toward the both edge portions. The flange portions 8 are formed on the both edge portions of the sheet body 6. The two flange portions 8 are protruded in opposite directions. This is because the convenience for the case where the sheet body 6 is installed on a vehicle is taken into consideration.

In the present technology, the protruding directions of the two flange portions may be the same.

FIG. 4 is an explanatory view illustrating an example of a method of installing the sheet body.

As illustrated in FIG. 4, one flange portion 8 is attached on the outer peripheral side of linear sections located at the top, bottom, left, and right of a vehicle 1 in a manner that the edge portion of the flange portion 8 faces inward of the vehicle 1. Thereafter, the other flange portion 8 is bended toward the direction shown by the arrow C in the figure in a manner that the cross section of the sheet body 6 becomes a substantially U-shape, and the other flange portion 8 is attached to the inner peripheral side of the linear sections of the vehicle 1.

Although the outside hood of the present technology was described specifically using an embodiment, the outside hood of the present technology is not limited to this. For example, as illustrated in FIG. 5, through holes 9 may be formed on a wall face of the shoulder member 4 of the outside hood to enhance workability during fixing of the outside hood onto the vehicle body, to release concentrated stress, and the like. Furthermore, a notched portion or the like may be formed on the shoulder member. Furthermore, the outside hood may have linear members only on the left and right sides.

### Examples

The present technology will be described below by means of examples. The present technology is not limited to such examples.

### Evaluation

The following evaluations were performed using the rubber composition produced as described below. The results are shown in the tables.

Taber Abrasion

A vulcanized rubber was obtained by press-vulcanizing the rubber composition produced as described below at 160° C. for 60 minutes. The obtained vulcanized rubber was formed into a disk shape. For this, the amount of wear (mm³) was measured after rotating 100 times using a Taber abrasion tester using the abrasion wheel CS-17 and an applied force of 9.8 N, in accordance with JIS K6264-2:2005.

Smaller wear amount indicated better wear resistance.

Tensile Test (Tensile Properties)

A vulcanized rubber was obtained by press-vulcanizing the rubber composition produced as described below at 160° C. for 60 minutes. The obtained vulcanized rubber was formed into a No. 3 dumbbell stipulated in JIS in accordance with JIS K6251:2010. Using this, a tensile test was performed at a tensile speed of 500 mm/min to measure the tensile strength at break (TS_{b}) or the elongation at break (E_{b}).

In the present technology, the tensile strength at break of 8.5 MPa or greater indicates excellent tensile strength at break, and the tensile strength at break of 10 MPa or greater indicates even better tensile strength at break.

In the present technology, the elongation at break of 350% or greater indicates excellent elongation at break.

### Production of the Rubber Composition

The components shown in the following tables (excluding the sulfur and the peroxide compound) at the amounts shown in the same table (part by mass) were loaded into a kneader mixer and mixed for approximately 15 minutes. Thereafter, the obtained rubber mixture was wound around a mill roll, and then the sulfur and/or the peroxide compound were added and kneaded for approximately 10 minutes to produce a rubber composition.

Note that, in each table, when the EPDM used in the rubber composition is one type, the value written for “average Mooney viscosity of EPDM” in the same table indicates the Mooney viscosity of the one type of EPDM. The same applies to the diene amount.

TABLE 1-1

| | EPDM No. (Mooney | | | | | | | | |
|---|---|---|---|---|---|---|---|---|---|
| | viscosity/ethylene | | | | | | | | |
| | amount: mass %/diene | Working Examples | | | | | | | |
| | amount: mass %) | 1 | 2 | 3 | 4 | 5 | 6 | 7 | 8 |
| EPDM 1 | 305 (60/60/7.5) | | | | | | | | |
| EPDM 2 | 505A (47/50/9.5) | | 70 | 55 | 45 | 55 | 55 | | 55 |
| EPDM 3 | 505 (75/50/10) | | 30 | 45 | 55 | 45 | 45 | 100 | 45 |
| EPDM 4 | 4070 (70/56/8) | 70 | | | | | | | |
| EPDM 5 | 4021 (24/51/8) | 30 | | | | | | | |
| EPDM 6 | EP43 (43/56/1.5) | | | | | | | | |
| Average Mooney viscosity of EPDM | | 56 | 55 | 60 | 62 | 60 | 60 | 75 | 60 |
| Average diene amount of EPDM (mass %) | | 8 | 9.7 | 9.7 | 9.8 | 9.7 | 9.7 | 10 | 9.7 |
| Silica | | 15 | 15 | 15 | 15 | 20 | 20 | 15 | 31 |
| Titanium oxide | | 50 | 50 | 50 | 50 | 50 | 40 | 50 | 50 |
| Diethylene glycol | | 1 | 1 | 1 | 1 | 1.3 | 1.3 | 1 | 2 |
| Silane coupling agent (Si 69) | | | | | | | 1 | | |
| Sulfur | | 1.58 | 1.58 | 1.58 | 1.58 | 1.58 | 1.58 | 1.58 | 1.58 |
| Taber abrasion | [mm³] | 0.53 | 0.58 | 0.59 | 0.57 | 0.54 | 0.42 | 0.52 | 0.48 |
| Tensile strength at break | [MPa] | 11.5 | 11.1 | 12.4 | 10.7 | 14.3 | 10.8 | 12.4 | 14.8 |
| (TS_{b}) | | | | | | | | | |

TABLE 1-2

| | EPDM No. (Mooney | | | | | |
|---|---|---|---|---|---|---|
| | viscosity/ethylene | | | | | |
| | amount: mass %/diene | Comparative Examples | | | | |
| | amount: mass %) | 1 | 2 | 3 | 4 | 5 |
| EPDM 1 | 305 (60/60/7.5) | 100 | | | | |
| EPDM 2 | 505A (47/50/9.5) | | | | 100 | 55 |
| EPDM 3 | 505 (75/50/10) | | | | | 45 |
| EPDM 4 | 4070 (70/56/8) | | | 30 | | |
| EPDM 5 | 4021 (24/51/8) | | | 70 | | |
| EPDM 6 | EP43 (43/56/1.5) | | 100 | | | |
| Average Mooney viscosity of EPDM | | 60 | 43 | 38 | 47 | 60 |
| Average diene amount of EPDM (mass %) | | 7.5 | 1.5 | 8 | 9.5 | 9.7 |
| Silica | | 15 | 15 | 15 | 15 | 4 |
| Titanium oxide | | 50 | 50 | 50 | 50 | 50 |
| Diethylene glycol | | 1 | 1 | 1 | 1 | 1 |
| Silane coupling agent (Si 69) | | | | | | |
| Sulfur | | 1.58 | 1.58 | 1.58 | 1.58 | 1.58 |
| Taber abrasion | [mm³] | 0.83 | 0.72 | 0.86 | 0.68 | 0.88 |
| Tensile strength at | [MPa] | 10.9 | 8.0 | 7.0 | 8.5 | 9.2 |
| break (TS_{b}) | | | | | | |

TABLE 2-1

| | EPDM No. (Mooney | | | | | | | | |
|---|---|---|---|---|---|---|---|---|---|
| | viscosity/ethylene amount: | | | | | | | | |
| | mass %/diene amount: | Working Examples | | | | | | | |
| | mass %) | 9 | 10 | 11 | 12 | 13 | 14 | 15 | 16 |
| EPDM 1 | 305 (60/60/7.5) | | | | | | | | |
| EPDM 2 | 505A (47/50/9.5) | 70 | 55 | | 55 | 55 | 55 | | |
| EPDM 3 | 505 (75/50/10) | 30 | 45 | | 45 | 45 | 45 | | |
| EPDM 4 | 4070 (70/56/8) | | | 100 | | | | | |
| EPDM 5 | 4021 (24/51/8) | | | | | | | | |
| EPDM 7 | (90/41/14) | | | | | | | 60 | 50 |
| EPDM 8 | (92/65/4.6) | | | | | | | 0 | 10 |
| EPDM 9 | (32/47/9.5) | | | | | | | 40 | 40 |
| Average Mooney viscosity of EPDM | | 55 | 60 | 70 | 60 | 60 | 60 | 67 | 67 |
| Average diene amount of EPDM (mass %) | | 9.7 | 9.7 | 8 | 9.7 | 9.7 | 9.7 | 12.2 | 11 |
| Carbon black | | 10 | 10 | 10 | 10 | 10 | 10 | 10 | 10 |
| Silica | | 15 | 15 | 25 | 25 | 20 | 15 | 20 | 15 |
| Talc | | 40 | 40 | 40 | 30 | 40 | 40 | 40 | 40 |
| Titanium oxide | | 10 | 10 | 10 | 10 | 10 | 10 | 10 | 10 |
| Aluminum hydroxide (HIGILITE) | | 50 | 50 | 50 | 50 | 50 | 50 | 50 | 50 |
| Flame retardant | | 25 | 25 | 25 | 25 | 25 | 25 | 25 | 25 |
| Ammonium polyphosphate | | 10 | 10 | 10 | 10 | 10 | 10 | 10 | 10 |
| Diethylene glycol | | 1 | 1 | 1 | 1 | 0.6 | 1 | 1 | 1 |
| Silane coupling agent (Si 69) | | | | | 1 | 0.7 | | | |
| Peroxide compound | | 7 | 7 | 7 | 7 | 7 | 7 | 7 | 7 |
| Sulfur | | 0.32 | 0.32 | 0.32 | 0.32 | 0.32 | 0.15 | 0.32 | 0.32 |
| Taber abrasion | [mm³] | 0.47 | 0.39 | 0.33 | 0.48 | 0.39 | 0.35 | 0.38 | 0.55 |
| Tensile strength | [MPa] | 8.9 | 10.1 | 10.0 | 10.1 | 8.3 | 9.3 | 8.3 | 8.6 |
| at break (TS_{b}) | | | | | | | | | |
| Elongation at | ≧350 [%] | 411 | 374 | 366 | 361 | 393 | 355 | 459 | 498 |
| break (E_{b}) | | | | | | | | | |

TABLE 2-2

| | EPDM No. (Mooney | | | |
|---|---|---|---|---|
| | viscosity/ethylene | | | |
| | amount: | Comparative | | |
| | mass %/diene amount: | Examples | | |
| | mass %) | 6 | 7 | 8 |
| EPDM 1 | 305 (60/60/7.5) | 100 | | |
| EPDM 2 | 505A (47/50/9.5) | | | |
| EPDM 3 | 505 (75/50/10) | | | |
| EPDM 4 | 4070 (70/56/8) | | 30 | 45 |
| EPDM 5 | 4021 (24/51/8) | | 70 | 55 |
| EPDM 7 | (90/41/14) | | | |
| EPDM 8 | (92/65/4.6) | | | |
| EPDM 9 | (32/47/9.5) | | | |
| Average Mooney viscosity of EPDM | | 60 | 38 | 45 |
| Average diene amount of EPDM (mass %) | | 7.5 | 8 | 8 |
| Carbon black | | 10 | 10 | 10 |
| Silica | | 15 | 15 | 15 |
| Talc | | 40 | 40 | 40 |
| Titanium oxide | | 10 | 10 | 10 |
| Aluminum hydroxide (HIGILITE) | | 50 | 50 | 50 |
| Flame retardant | | 25 | 25 | 25 |
| Ammonium polyphosphate | | 10 | 10 | 10 |
| Diethylene glycol | | 1 | 1 | 1 |
| Silane coupling agent (Si 69) | | | | |
| Peroxide compound | | 7 | 7 | 7 |
| Sulfur | | 0.32 | 0.32 | 0.32 |
| Taber abrasion | [mm³] | 0.56 | 0.86 | 0.88 |
| Tensile strength at | [MPa] | 8.8 | 6.3 | 6.4 |
| break (TS_{b}) | | | | |
| Elongation at | ≧350[%] | 333 | 485 | 458 |
| break (E_{b}) | | | | |

The components shown in Tables 1 and 2 are as follows.
EPDM 1: ESPRENE 305 (manufactured by Sumitomo Chemical Co., Ltd.), weight average molecular weight: 27×10⁴
EPDM 2: ESPRENE 505A (manufactured by Sumitomo Chemical Co., Ltd.)
EPDM 3: ESPRENE 505 (manufactured by Sumitomo Chemical Co., Ltd.), weight average molecular weight: 60×10⁴
EPDM 4: ESPRENE 4070 (manufactured by Sumitomo Chemical Co., Ltd.)
EPDM 5: ESPRENE 4021 (manufactured by Sumitomo Chemical Co., Ltd.)
EPDM 6: EP 43 (manufactured by JSR Corporation)
EPDM 7: Mitsui EPT 9090M (manufactured by Mitsui Chemicals, Inc.)
EPDM 8: Mitsui EPT 3092M (manufactured by Mitsui Chemicals, Inc.)
EPDM 9: Mitsui EPT 8030M (manufactured by Mitsui Chemicals, Inc.)
Carbon black: trade name: Asahi #50, manufactured by Asahi Carbon Co., Ltd.
Silica: Nipsil VN3 (manufactured by Nippon Silica Industries)
Talc: N Talc (manufactured by Nippon Talc Co., Ltd.)
Titanium oxide: R-650 (manufactured by Sakai Chemical Industry Co., Ltd.)
Aluminum hydroxide: HIGILITE H-42M (manufactured by Showa Denko K.K.)
Flame retardant: trade name: SAYTEX8010, manufactured by Albemarle Corporation, ethylenebis(pentabromophenyl)
Ammonium polyphosphate: trade name: Sumisafe P, manufactured by Sumitomo Chemical Co., Ltd.
Diethylene glycol: manufactured by Maruzen Petrochemical Co., Ltd.
Silane coupling agent: bis(triethoxysilylpropyl) tetrasulfide, Si 69, manufactured by Evonik Degussa
Peroxide compound: PERCUMYL D-40 (manufactured by Nippon Oil & Fats Co., Ltd.), dicumylperoxide
Sulfur: Powdered sulfur (manufactured by Karuizawa Refinery Ltd.)

As is clear from the results shown in Table 1, Working Examples 1 to 8 exhibited higher wear resistance compared to those of Comparative Examples 1 to 5.

It is conceived that this result is because, for Comparative Example 1, the diene amount of EPDM was less than 8 mass %.

For Comparative Example 2, it is conceived that this is because the Mooney viscosity of EPDM was less than 50 and the diene amount was less than 8 mass %.

For Comparative Example 3, it is conceived that this is because the average Mooney viscosity of EPDMs was less than 50.

For Comparative Example 4, it is conceived that this is because the Mooney viscosity of EPDM was less than 50.

For Comparative Example 5, it is conceived that this is because the amount of the silica was less than the predetermined amount.

When Working Examples 3, 4, and 7 are compared, as the average Mooney viscosity and the average diene amount of EPDMs were increased, the wear resistance was made even better.

Furthermore, when Working Examples 3, 5, and 8 are compared, as the amount of the silica was increased, the wear resistance was made even better and the tensile strength at break was made even higher.

As is clear from the results shown in Table 2, Working Examples 9 to 16 exhibited higher wear resistance compared to those of Comparative Examples 6 to 8.

It is conceived that this result is because, for Comparative Example 6, the diene amount of EPDM was less than 8 mass %.

For Comparative Examples 7 and 8, it is conceived that this is because the average Mooney viscosity of EPDMs was less than 50.

Furthermore, when Working Example 9 and Working Example 10 are compared, it was conceived that, as the average Mooney viscosity of EPDMs was higher, the wear resistance and the tensile strength at break were made even better.

When Working Example 12 and Working Example 13 are compared, it was conceived that, by reducing the content of the diethylene glycol and the silane coupling agent, even better wear resistance and excellent elongation at break were achieved.

When Working Example 10 and Working Example 14 are compared, it was conceived that, by reducing the content of the sulfur, even better wear resistance was achieved.

When Working Example 15 and Working Example 16 are compared, when the two or more types of EPDMs were used and, among these, the diene amount of at least one type of EPDM was 5 mass % or less, it was conceived that excellent tensile strength at break and elongation at break were achieved compared to the case where

EPDM having the diene amount of 5 mass % or less was not contained.

1. A rubber composition for an outside hood, the rubber composition comprising, per 100 parts by mass of one type or two or more types of ethylene-propylene-diene terpolymers,
5 parts by mass or greater of silica, and
at least one selected from the group consisting of sulfur and a peroxide compound,
a Mooney viscosity of the one type of ethylene-propylene-diene terpolymer being 50 or greater, a diene amount in the one type of ethylene-propylene-diene terpolymer being 8 mass % or greater of the one type of ethylene-propylene-diene terpolymer,
an average Mooney viscosity of the two or more types of ethylene-propylene-diene terpolymers being 50 or greater, and an average diene amount in the two or more types of ethylene-propylene-diene terpolymers being 8 mass % or greater of the two or more types of ethylene-propylene-diene terpolymers.

2. The rubber composition for an outside hood according to claim 1, wherein the amount of the silica is from 10 to 50 parts by mass per 100 parts by mass of the one type or two or more types of ethylene-propylene-diene terpolymers.

3. The rubber composition for an outside hood according to claim 1, wherein an amount of the sulfur is from 0.1 to 4 parts by mass per 100 parts by mass of the one type or two or more types of ethylene-propylene-diene terpolymers.

4. The rubber composition for an outside hood according to claim 1, wherein the amount of the sulfur is from 0.2 to 4 parts by mass per 100 parts by mass of the one type or two or more types of ethylene-propylene-diene terpolymers.

5. The rubber composition for an outside hood according to claim 1, wherein an amount of the peroxide compound is from 1 to 10 parts by mass per 100 parts by mass of the one type or two or more types of ethylene-propylene-diene terpolymers.

6. The rubber composition for an outside hood according to claim 1, further comprising diethylene glycol, wherein
an amount of the diethylene glycol is from 0.1 to 3 parts by mass per 100 parts by mass of the one type or two or more types of ethylene-propylene-diene terpolymers.

7. The rubber composition for an outside hood according to claim 1, further comprising carbon black, wherein
an amount of the carbon black is 10 parts by mass or less per 100 parts by mass of the one type or two or more types of ethylene-propylene-diene terpolymers.

8. The rubber composition for an outside hood according to claim 1, comprising the two or more types of ethylene-propylene-diene terpolymers, wherein
at least one type of the two or more types of ethylene-propylene-diene terpolymers is an ethylene-propylene-diene terpolymer having a Mooney viscosity of 50 or greater, and
at least another one type of the two or more types of ethylene-propylene-diene terpolymers is an ethylene-propylene-diene terpolymer having a Mooney viscosity of less than 50.

9. The rubber composition for an outside hood according to claim 1, comprising the two or more types of ethylene-propylene-diene terpolymers, wherein
among the two or more types of ethylene-propylene-diene terpolymers, each of diene amounts of at least two types of ethylene-propylene-diene terpolymers is 8 mass % or greater of each of the ethylene-propylene-diene terpolymers.

10. The rubber composition for an outside hood according to claim 1, comprising the two or more types of ethylene-propylene-diene terpolymers, wherein
among the two or more types of ethylene-propylene-diene terpolymers, a diene amount of at least one type of ethylene-propylene-diene terpolymer is 5 mass % or less of the at least one type of ethylene-propylene-diene terpolymer.

11. The rubber composition for an outside hood according to claim 1, comprising three types of the ethylene-propylene-diene terpolymers, wherein
among the three types of ethylene-propylene-diene terpolymers, a diene amount of one type of ethylene-propylene-diene terpolymer X is 5 mass % or less of the one type of ethylene-propylene-diene terpolymer X.

12. The rubber composition for an outside hood according to claim 1, further comprising a flame retardant.

13. The rubber composition for an outside hood according to claim 1, further comprising a silane coupling agent, wherein
a content of the silane coupling agent is from 0.1 to 10 parts by mass per 100 parts by mass of the one type or two or more types of ethylene-propylene-diene terpolymers.

14. The rubber composition for an outside hood according to claim 13, wherein the silane coupling agent is a sulfur-based silane coupling agent having a sulfur atom.

15. An outside hood for a railway vehicle produced by using the rubber composition for an outside hood described in claim 1.
